(19) United States
(12) Patent Application Publication
(10) Pub. No.: US 2016/0318493 A1
(43) Pub. Date: Nov. 3, 2016

(54) Anti-jackknifing apparatus for articulated vehicles

(71) Applicant: Dean Drako, Austin, TX (US)

(72) Inventor: Dean Drako, Austin, TX (US)

(21) Appl. No.: 15/206,927

(22) Filed: Jul. 11, 2016

Related U.S. Application Data
(63) Continuation-in-part of application No. 14/549,448, filed on Nov. 20, 2014, now Pat. No. 9,421,883.
(60) Provisional application No. 61/950,229, filed on Mar. 10, 2014.

(51) Int. Cl. B60T 8/24; B62D 53/08; B60T 8/1755; B60T 8/17; B60K 7/00; B60T 7/20

(52) U.S. Cl. CPC B60T 8/248; B60K 7/0007; B60T 7/20; B60T 8/1755; B60T 8/1708; B62D 53/0878; B60T 2230/06; B60Y 2200/148; B60Y 2300/28

(57) ABSTRACT

A system averts catastrophic folding of an articulated vehicle e.g. jack-knifing a tractor against its attached trailer when tires have lost adhesion to a road surface. The apparatus includes independent port and starboard AC motor controllers that convert DC power to AC phases and magnitudes. A battery is regeneratively charged during normal braking operation of the vehicle and discharged when the AC motors apply torque to wheels. Sensors determine when the AC motor controllers provide phases and magnitudes that result in a positive torque to one or more motors and a negative torque to a different one or more motors. The apparatus operates by generating a horizontal yaw force on the trailer in opposition to closing the angle between the tractor and the trailer; by applying a rotational force on the fifth wheel; and by unbalanced torque applied to the tractor's port and starboard driven wheels.

### CROSS-REFERENCES TO RELATED APPLICATIONS

This non-provisional application is a continuation in part application of Ser. No. 14/549,448 Adaptive torque control circuit and method of operation which is incorporated by reference in its entirety and benefits from its priority date Nov. 20, 2014.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

1. Technical Field

The present invention relates highway safety for articulated vehicles. The invention uses electrically powered wheels for stability.

2. Description of the Related Art

As is known, electrical current magnitude and phase controls the torque provided by poly-phase motors.

Vehicle yaw force can be generated by wheels receiving a braking torque on one side of the vehicle or by wheels receiving a drive torque on another side of the vehicle or by the combination of both.

As is known, tractor-trailer configurations of heavy duty trucking have an instability which is nearly impossible to recover from. When the vehicle loses traction during an emergency braking event, the forward momentum of the trailer causes the rear wheels of the tractor to break away i.e. skid sideways. Reaction time of the driver to correct the skid is frequently too slow to succeed.

What is needed is an apparatus to sense when a critical angle and speed is exceeded on an articulated vehicle and to apply a horizontal yaw force on the trailer.

What is needed are tractor and trailer components that resist jackknifing operating independently or in coordination.

### BRIEF SUMMARY OF THE INVENTION

A system averts folding of an articulated vehicle e.g. jack-knifing a tractor against its attached trailer when tires have lost adhesion to a road surface causing the towing component to partially face rearward.

An unfolding force is generated by electrical currents. This may occur directly by operating at the kingpin or fifth wheel. Current directed to motors coupled to wheels in contact with the road surface will also create yaw forces on the tractor, or the trailer.

The apparatus includes independent port and starboard AC motor controllers that convert DC power to AC phases and magnitudes. A vehicle control circuit determines when motors driving the left and right sides of the vehicle should receive unbalanced power. A yaw force causes the tractor or trailer to rotate horizontally about its vertical axis.

A battery is regeneratively charged during normal braking operation of the vehicle and discharged when the AC motors apply torque to wheels. Each motor acts as an electrical generator when brakes are applied. The resulting current is used to charge the battery. When an AC motor controller provides a current to a motor at a phase and magnitude the battery is discharged.

Sensors cause the AC motor controllers to provide phases and magnitudes that result in a positive torque to one or more motors and a negative torque to a different one or more motors. Sensors detect if the wheels are skidding or sliding. Sensors detect if the angle of articulation between the trailer and the tractor is becoming too acute or insufficiently obtuse for the speed.

The angle between the tractor and the trailer may be increased by generating a horizontal yaw force on the trailer; by applying a rotational force on the fifth wheel; and by unbalanced torque applied to the tractor's port and starboard driven wheels. A negative torque on the side of a trailer that the tractor is converging toward will force the front of the trailer to yaw toward the tractor and avoid spinning the tractor.

If the kingpin or turntable of the articulated vehicle contains an electric motor, current applied there can increase rigidity leftward or rightward to resist jack-knifing.

Whether the tractor is front wheels driven, rear wheels driven, or all wheels driven, phases and magnitudes provided to the AC motors will provide forces toward closer alignment of the tractor with the trailer.

### BRIEF DESCRIPTION OF THE SEVERAL VIEWS OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a top down view of an articulated vehicle traveling forward in line with vectors of force and momentum aligned;

FIG. 2 illustrates a top down view of an articulated vehicle turning leftward with arrows indicating the momentum of the tractor and its trailer;

FIG. 3 illustrates a top down view of an articulated vehicle at cusp of a catastrophic jackknifing event with arrows showing the forces applied on the trailer and on the tractor, resulting in yaw force on the tractor.

FIG. 4 illustrates a top down view of an articulated vehicle at risk of jackknifing with arrows illustrating desirable forces generated by the invention;

FIG. 5 is a block diagram of components and subsystem of an anti-jackknifing apparatus of an articulated vehicle;

FIG. 6 is a block diagram of a processor suitable for performance of a method embodiment; and

FIG. 7 is an illustration of processes in a method embodiment.

### DETAILED DISCLOSURE OF EMBODIMENTS OF THE INVENTION

When a sensor subsystem measures that the angle between a trailer and a rear axel of a tractor exceeds a limit inconsistent with safe road surface and wheel speed, yaw forces are generated by wheels coupled to poly-phase electric motors to avoid a jackknife configuration. Positive and negative torque is generated by current magnitude and current phase supplied to one or more motors.

An apparatus is disclosed for avoidance of undesired folding of an articulated vehicle in a skidding movement including: an electrical power supply, at least one electrical motor controller, a vehicle controller, at least one electric motor, and sensors to detect a skidding movement and an undesirably obtuse angle between a trailer and its tractor.

More typically, one side of the trailer receives positive drive torque while the other side receives negative braking torque to generate a yaw force to bring the tractor and trailer more into alignment.

A method for operation of the anti-jackknifing apparatus includes: determining that a skidding movement is occurring; determining that the angle of the tractor and its trailer is near instability; determining at least one desired yaw direction to avoid folding of the articulated vehicle; and at least one of applying electrical current to force generator at a fifth wheel to stiffen the articulation of a vehicle and resist further folding toward an acute angle; applying AC phase and magnitude unequally to port and starboard electric motors coupled to a trailer's wheels to generate a yaw movement of the trailer toward the front of the tractor; and applying AC phase and magnitude unequally to port and starboard electric motors coupled to a tractor's wheels to create a horizontal yaw moment to increase alignment of the tractor with its trailer.

A system averts folding of an articulated vehicle e.g. jack-knifing a tractor against its attached trailer when tires have lost adhesion to a road surface causing the towing component to partially face rearward.

An unfolding force is generated by electrical currents. This may occur directly by operating at the kingpin or fifth wheel.

Current directed to motors coupled to wheels in contact with the road surface will also create yaw forces on the tractor, or on the trailer.

The apparatus includes independent port and starboard AC motor controllers that convert DC power to AC phases and magnitudes.

A vehicle control unit (VCU) circuit determines when motors driving the port and starboard sides of the vehicle receive unbalanced power.

A yaw force will cause the tractor or trailer to rotate horizontally about its vertical axis.

A battery is regeneratively charged during normal braking operation of the vehicle and discharged when the AC motors apply torque to wheels. Other stored energy may be chemical or kinetic.

Each motor acts as an electrical generator when brakes are applied. The resulting current is used to charge the battery.

When an AC motor controller provides a current to a motor at a phase and magnitude the energy store is discharged.

Sensors cause the AC motor controllers to provide current phases and magnitudes that result in a positive torque to one or more motors and a negative torque to a different one or more motors. A VCU transforms sensor data to torque commands.

Sensors detect if the wheels are skidding or sliding.

Sensors detect if the angle of articulation between the trailer and the tractor is becoming too acute or insufficiently obtuse for the speed.

The angle between the tractor and the trailer may be increased by generating a horizontal yaw force on the trailer; by applying a rotational force on the fifth wheel; and by unbalanced torque applied to the tractor's port and starboard driven wheels.

A negative torque on the side of a trailer that the tractor is converging toward will force the front of the trailer to yaw toward the tractor and avoid spinning the tractor.

When the kingpin or turntable of the articulated vehicle contains an electric motor, current applied there increases rigidity leftward or rightward to resist jack-knifing and support aligning.

Whether the tractor is front wheels driven, rear wheels driven, or all wheels driven, phases and magnitudes provided to AC motors will provide forces toward closer alignment of the tractor with the trailer. Below a speed threshold, this is unnecessary.

An apparatus comprises a plurality of independent AC motors, each coupled to the port and to the starboard wheels of a trailer; a battery; and a control circuit to independently control phase and magnitude of the motor coupled to the port wheel(s) and the motor coupled to the starboard wheel(s).

Two effects may operate independently or be combined. A stiffening effect may be provided at the kingpin joining the tractor to the trailer that resists further folding and support unfolding. A yaw effect may be provided by braking and drive torques applied asymmetrically to wheels on the port or starboard sides.

The present disclosure provides now non-limiting illustrative figures which aid the comprehension of the invention by representative cases.

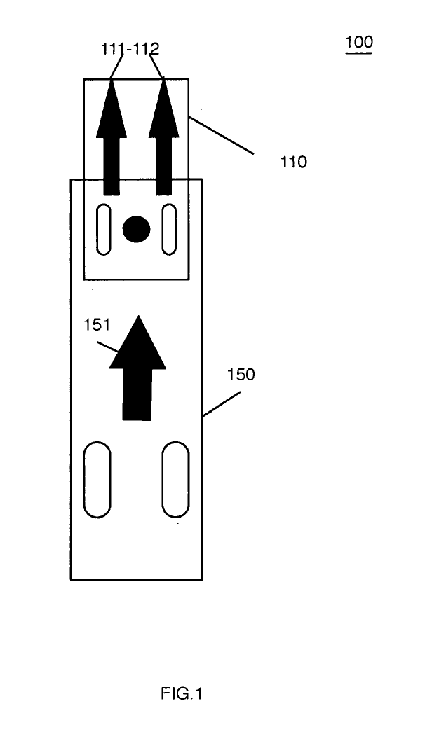

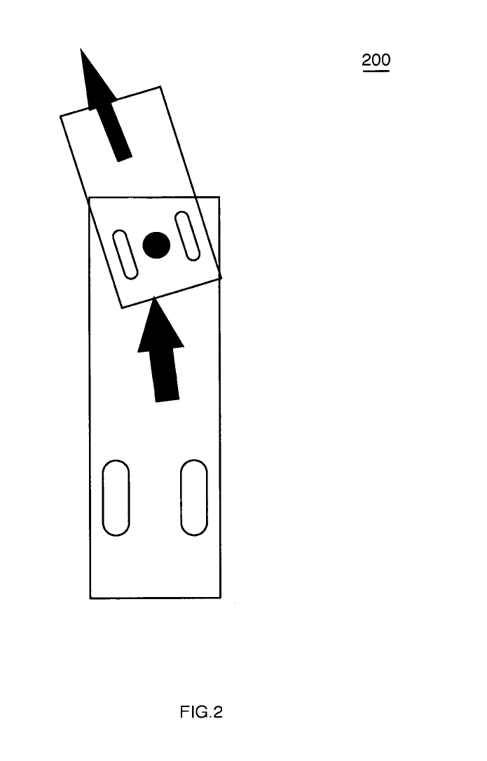

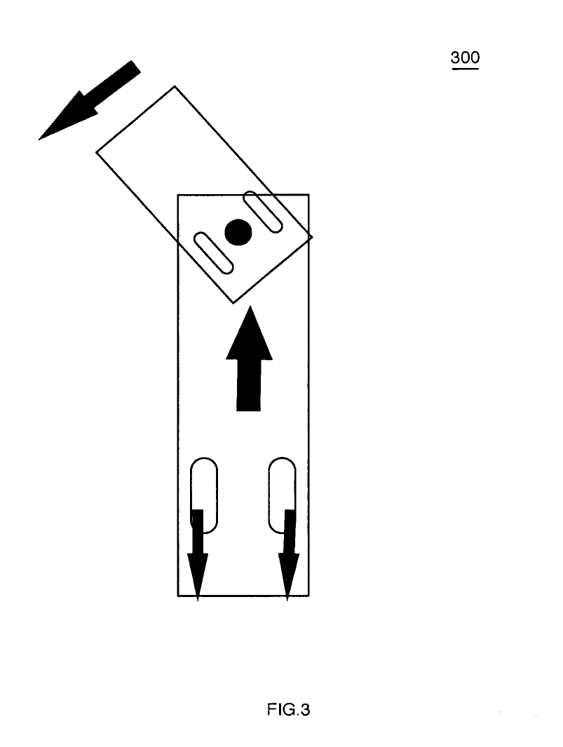

FIG.1 shows a tractor coupled to a trailer at a pivot point. FIG. 2 shows a stable turn of the vehicle traveling forward. FIG. 3 shows a pre-jack-knifing situation where brakes applied to the wheels of the trailer cause a negative torque but the momentum of the trailer applied to the pivot point of the tractor causes the tractor to turn counter-clockwise.

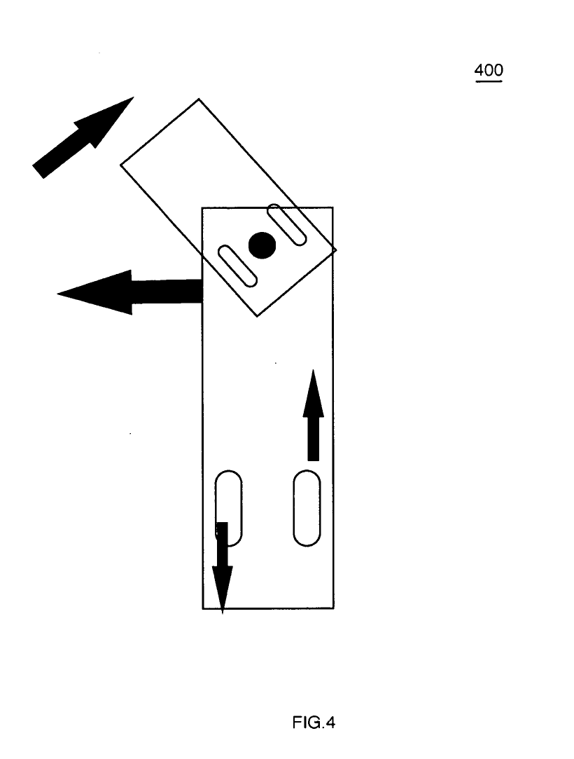

In FIG.4 a vehicle 400 has exceeded the critical angle and speed of stability. The control circuit upon sensing an instability leading to jack-knifing of the vehicle controls the phase and amplitude to the motors to cause a positive torque force on the starboard wheel(s) and a negative torque force on the port wheel(s).

The combination of forces results in a counter-clockwise yaw force on the trailer. The trailer transmits this force to the tractor at the pivot which assists the driver in recovery.

### Five Wheel Drive

In this configuration, four motors apply torque to wheels that are in contact with the ground and a fifth motor applies torque to the pivot between the trailer and its tractor. Normally this pivot is low friction and allows the trailer to swing behind the tractor. In this 5th wheel drive mode, the motor can influence the rigidity of the vehicle as a whole. That is, it resists further folding and supports unfolding. When a rate of speed and turning may approach the instability of jack-knifing the combination of trailer and tractor, the 5th wheel stiffens the vehicle in one direction but enables it to straighten in the other. That is increasing angle between tractor's axis and trailer's axis is increasingly resisted but decreasing angle toward alignment is assisted. The five electrically powered motors are the port and starboard of the tractor, the port and starboard rear of the trailer, and the turn-table or coupling linking the tractor to the trailer. A kingpin serves as the axel of the fifth wheel.

In embodiments, the tractor may power the front steering wheels or the rear trailer weight bearing wheels.

The electrical motors charge the battery during regenerative braking and is quieter than conventional engine or friction brakes.

### 4-6 Wheel Drive.

In this configuration, the motors beneath the front of the trailer are used in their normal function to pull the trailer and during regenerative braking to charge a battery. However, the control circuit adds a differential torque between the port and starboard wheels to resist a folding or jack-knife instability. The front wheels of the tractor are powered in one embodiment and not in another embodiment.

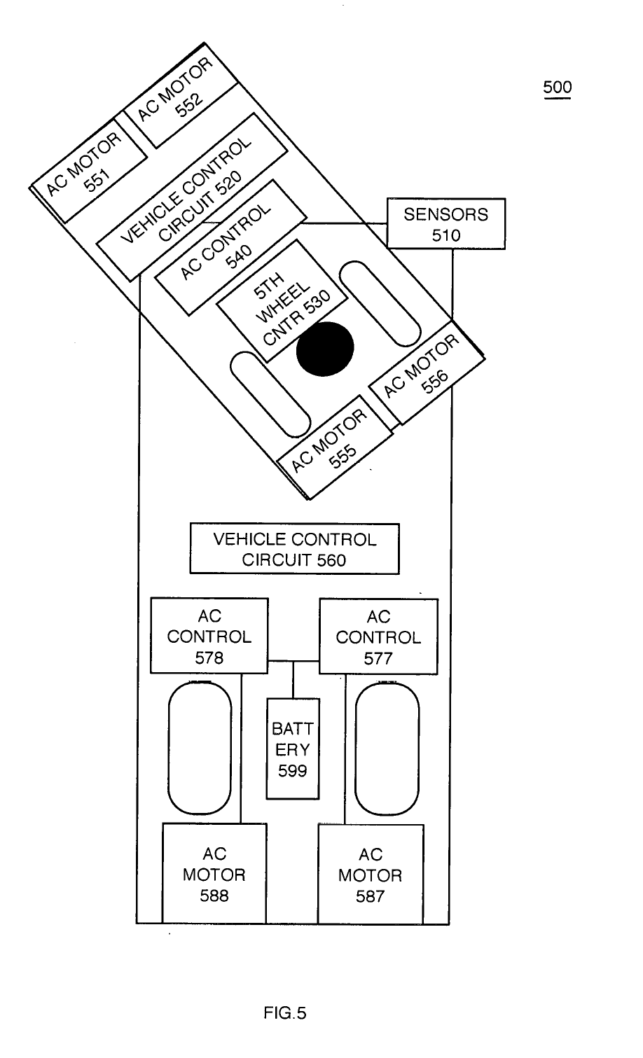

FIG. 5 is a block diagram of a system.

Referring now to FIG. 5, a block diagram illustrates several non-limiting exemplary embodiments of the invention:

The invention provides a 5th wheel controller 530 that is activated by the vehicle control circuit 520 when sensors 510 determine that the articulated vehicle is imminently vulnerable to jackknife movement based on received skid, slide, and orientation physical measures. The 5th wheel controller resists further closing of the angle between the tractor and the trailer but applies an angular force to open the angle toward improved alignment of tractor and trailer.

In addition or alternately, the invention provides at least one alternating current (AC) control circuit 540 to provide AC phase and magnitude to at least two AC motors 551 552 555 556 as activated by the vehicle control circuit 520 when sensors 510 determine that the articulated vehicle is imminently vulnerable to jackknife movement. Positive or negative torque applied by the wheels due to the AC phase and magnitude result in a yaw force on the tractor which averts a jackknife instability. A battery or alternator or generator (not shown) provides the energy for both positive and negative motor torque.

In addition or alternately, the invention provides a trailer based apparatus to use battery 599 power to generate yaw forces to counteract jackknifing. The port and starboard AC motors 588 587 receive AC phase and magnitude from the AC control circuits 578 577 according to the desired yaw to counteract jackknifing as determined by the vehicle control circuit 560 when sensors 510 determine that the articulated vehicle is imminently vulnerable to jackknife movement based on received skid, slide, and orientation physical measures. Regenerative braking circuits (not shown) allow the trailer to operate without dependency on tractor power supply or control systems or particular sensitivity to tractor makes, models, or generations. Improved trailers may operate with legacy tractors.

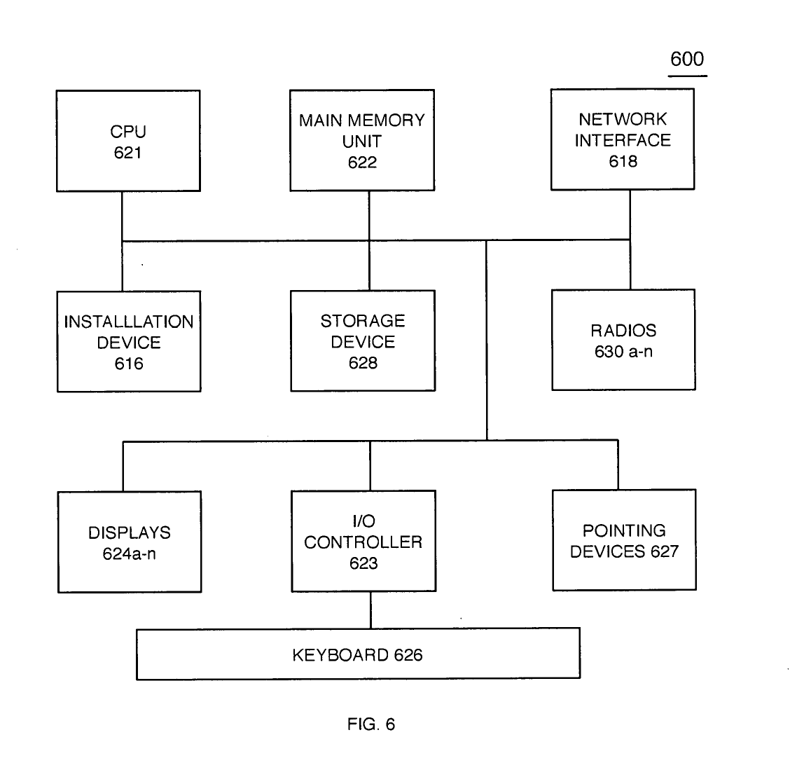

FIG. 6 is a block diagram of a processor embodiment of circuits used in the system. Exemplary processors suitable for the performance of method embodiments to sense conditions of road surface, wheels, and angles between a trailer and its tractor and control drive or braking torque to cause anti-jackknifing yaw forces are illustrated in FIG. 6.

FIG. 6 depicts block diagrams of a computing device 600 useful for practicing an embodiment of the invention. As shown in FIG. 6, each computing device 600 includes a central processing unit 621, and a main memory unit 622. A computing device 600 may include a storage device 628, an installation device 616, a network interface 618, an I/O controller 623, display devices 624a-n, a keyboard 626, a pointing device 627, such as a mouse or touchscreen, and one or more other I/O devices 630a-n such as baseband processors, Bluetooth, GPS, and Wi-Fi radios. The storage device 628 may include, without limitation, an operating system and software.

The central processing unit 621 is any logic circuitry that responds to and processes instructions fetched from the main memory unit 622. In many embodiments, the central processing unit 621 is provided by a microprocessor unit, such as: those manufactured under license from ARM; those manufactured under license from Qualcomm; those manufactured by Intel Corporation of Santa Clara, Calif.; those manufactured by International Business Machines of Armonk, N.Y.; or those manufactured by Advanced Micro Devices of Sunnyvale, Calif. The computing device 600 may be based on any of these processors, or any other processor capable of operating as described herein.

Main memory unit 622 may be one or more memory chips capable of storing data and allowing any storage location to be directly accessed by the microprocessor 621. The main memory 622 may be based on any available memory chips capable of operating as described herein.

Furthermore, the computing device 600 may include a network interface 618 to interface to a network through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax and direct asynchronous connections). In one embodiment, the computing device 600 communicates with other computing devices 600 via any type and/or form of gateway or tunneling protocol such as Secure Socket Layer (SSL) or Transport Layer Security (TLS). The network interface 618 may comprise a built-in network adapter, network interface card, PCMCIA network card, card bus network adapter, wireless network adapter, USB network adapter, modem or any other device suitable for interfacing the computing device 600 to any type of network capable of communication and performing the operations described herein.

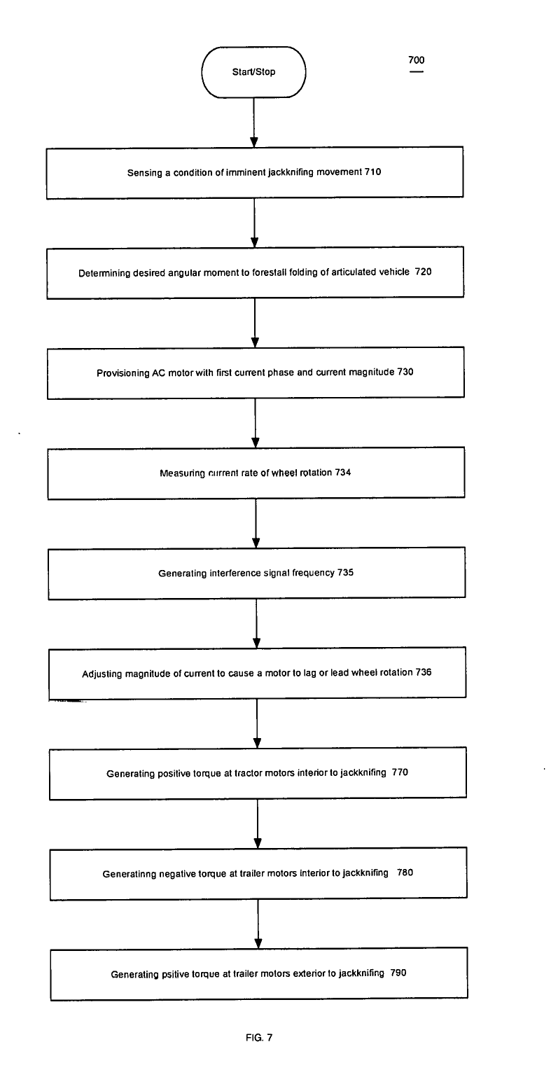

FIG. 7 is a flowchart of a method having the steps: sensing 710 from vehicle movement, wheel rotation, and orientation a condition of imminent jackknifing movement; determining 720 a desired angular moment to apply to a vehicle component to forestall a folding of the articulated vehicle; provisioning 730 at least one AC motor with a first current phase and current magnitude until the jackknifing movement is reversed; measuring 734 a current rate of wheel rotation; generating 735 an interference electrical signal of frequency above or below the current rate; adjusting 736 the magnitude of the current to cause the motor to lag or lead the wheel rotation; generating positive torque 770 at the electric motors of the tractor interior to the jackknifing movement of the articulated vehicle; generating negative torque 780 at the electric motors of the trailer interior to the jackknifing movement of the articulated vehicle; and generating positive torque 790 at the electric motors of the trailer exterior to the jackknifing movement of the articulated vehicle.

One aspect of the invention is a trailer that may be coupled to any tractor. It is self-contained by having power storage, sensors, motor controllers, and poly-phase motors that can apply braking torque to wheels asymmetrically causing an anti-yaw force.

Power storage may be chemical, mechanical, or electrical by regenerative braking or distribution off the powerplant of the tractor.

One aspect of the invention is an articulated vehicle that includes: an anti-jackknifing vehicle control circuit; at least one voltage and current motor controller; at least one electric motor coupled to a wheel; and a trailer.

In an embodiment, the articulated vehicle also includes: a tractor coupled to the trailer by a fifth wheel coupling; and sensors to determine when the tractor is both skidding and out of alignment to the trailer.

In an embodiment, the tractor includes a motor controller coupled to the fifth wheel coupling whereby voltage and current are applied to oppose increased folding of the articulated vehicle.

In an embodiment, the tractor includes: a plurality of AC motors; and at least one AC motor controller whereby AC phase and magnitude are applied to said motors to oppose increased folding of the articulated vehicle.

In an embodiment of the articulated vehicle said tractor includes the vehicle anti-jackknife control circuit coupled to said sensors whereby a first AC motor controller provides a first AC phase and magnitude to port motors to generate a horizontal yaw force counter to jackknifing and a second AC motor controller provides a second AC phase and magnitude to starboard motors to generate a horizontal yaw force counter to jackknifing.

In an embodiment of the articulated vehicle said trailer includes a motor controller coupled to the fifth wheel coupling whereby voltage and current are applied to oppose increased folding of the articulated vehicle.

In an embodiment of the articulated vehicle said trailer includes: a plurality of AC motors; and at least one AC motor controller whereby AC phase and magnitude are applied to said motors to oppose increased folding of the articulated vehicle.

In an embodiment of the articulated vehicle said trailer includes the vehicle anti-jackknife control circuit coupled to said sensors whereby a first AC motor controller provides a first AC phase and magnitude to port motors to generate a horizontal yaw force counter to jackknifing and a second AC motor controller provides a second AC phase and magnitude to starboard motors to generate a horizontal yaw force counter to jackknifing.

In an embodiment the articulated vehicle also has a regenerative braking circuit; coupled to a DC storage battery, said battery coupled to at least one AC motor controller.

In an embodiment of the articulated vehicle said tractor also includes the vehicle anti-jackknife control circuit coupled to said sensors whereby a first AC motor controller provides a first AC phase and magnitude to port motors to generate a horizontal yaw force counter to jackknifing and a second AC motor controller provides a second AC phase and magnitude to starboard motors to generate a horizontal yaw force counter to jackknifing; whereby the yaw forces of the tractor cause a clockwise moment and the yaw forces of the trailer cause a counter clockwise moment combined at a kingpin.

Another aspect of the invention is an anti-jackknifing apparatus for an articulated vehicle that includes: a plurality of electric motors adapted to apply torque to wheels; a current control circuit coupled to the plurality of electric motors and further coupled to a vehicle control circuit; and a plurality of sensors to determine skidding, sliding, and orientation.

In an embodiment of the anti-jackknifing apparatus, at least one motor is coupled to a fifth wheel to apply torque in resistance to folding of the articulated vehicle.

In an embodiment of the anti-jackknifing apparatus, a plurality of motors are configured to individually produce positive torque to wheels on a port side and negative torque to wheels on a starboard side.

In an embodiment of the anti-jackknifing apparatus, the current control circuit provides alternating current (AC) at a first phase and magnitude for motors associated with port side wheels and at a second phase and magnitude for motors associated with starboard side wheels.

In an embodiment of the anti-jackknifing apparatus, said sensors are coupled to the vehicle control unit to trigger currents applied to the motors.

In an embodiment, the anti-jackknifing apparatus also includes, an electrical power source coupled to the current control circuit and wherein regenerative braking circuits are coupled to the electrical power source.

Another aspect of the invention is a method for operation of an articulated vehicle controller and anti-jackknife apparatus having the processes: sensing from vehicle movement, wheel rotation, and orientation a condition of imminent jackknifing movement; determining a desired angular moment to apply to a vehicle component to forestall a folding of the articulated vehicle; and provisioning at least one AC motor with a first current phase and current magnitude until the jackknifing movement is reversed.

In an embodiment of the method provisioning at least one AC motor has the processes: measuring a current rate of wheel rotation; generating an interference electrical signal of frequency above or below the current rate; and adjusting the magnitude of the current to cause the motor to lag or lead the wheel rotation.

In an embodiment of the method wherein a vehicle component Is a tractor and a desired angular moment is a yaw of the tractor into closer alignment with the trailer, the method includes: generating positive torque at the electric motors of the tractor interior to the jackknifing movement of the articulated vehicle.

In an embodiment of the method wherein a vehicle component is a trailer and a desired angular moment is a yaw of the trailer into closer alignment with the tractor, the method includes: generating negative torque at the electric motors of the trailer interior to the jackknifing movement of the articulated vehicle; and generating positive torque at the electric motors of the trailer exterior to the jackknifing movement of the articulated vehicle.

A computing device 600 of the sort depicted in FIG.6 typically operates under the control of operating systems, that control scheduling of tasks and access to system resources. The computing device 600 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 10 and WINDOWS VISTA, manufactured by Microsoft Corporation of Redmond, Wash.; MAC OS and iOS, manufactured by Apple Inc., of Cupertino, Calif.; or any type and/or form of a Unix operating system.

In some embodiments, the computing device 600 may have different processors, operating systems, and input devices consistent with the device. In other embodiments the computing device 600 is a mobile device, such as a JAVA-enabled cellular telephone or personal digital assistant (PDA). The computing device 600 may be a mobile device such as those manufactured, by way of example and without limitation, Kyocera of Kyoto, Japan; Samsung Electronics Co., Ltd., of Seoul, Korea; Nokia of Finland; Hewlett-Packard Development Company, L.P. and/or; Sony Ericsson Mobile Communications AB of Lund, Sweden; or Research In Motion Limited, of Waterloo, Ontario, Canada.

In some embodiments, the computing device 600 comprises a combination of devices, such as a mobile phone combined with a digital audio player or portable media player. In another of these embodiments, the computing device 600 is device in the iPhone smartphone line of devices, manufactured by Apple Inc., of Cupertino, Calif. In still another of these embodiments, the computing device 600 is a device executing the Android open source mobile phone platform distributed by the Open Handset Alliance; for example, the device 600 may be a device such as those provided by Samsung Electronics of Seoul, Korea, or HTC Headquarters of Taiwan, R.O.C. In other embodiments, the computing device 600 is a tablet device such as, for example and without limitation, the iPad line of devices, manufactured by Apple Inc.; the Galaxy line of devices, manufactured by Samsung; and the Kindle manufactured by Amazon, Inc. of Seattle, Wash.

### CONCLUSION

The invention is easily distinguished from conventional anti-jackknifing apparatus that only applied anti-lock braking (pulsation) to conventional friction brakes. The invention is easily distinguished from conventional anti-jackknifing apparatus that only applies variable braking power to one side or to the other. The invention is easily distinguished from conventional anti-swing solutions to be manually engaged or automatically deactivated at low speeds. Conventional solutions cannot apply positive torque to wheels to create a yaw force on a tractor or a trailer. The invention is easily distinguished by its stored energy from conventional differential gears.

Advantageously, the regenerative braking is quieter in descending hills and charges an energy store which assists in climbing hills and with the introduction of sensors reduces the risk of jackknifing the tractor-trailer combination. The system also dampens sway oscillation of the cargo due to wind or paving.

The techniques described herein can be implemented in digital electronic circuitry, or in computer hardware, firmware, software, or in combinations of them. The techniques can be implemented as a computer program product, i.e., a computer program tangibly embodied in a non-transitory information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; internal hard disks or removable disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

1. An anti-jackknifing trailer comprises:
a sensor system to measure speed of wheels, road surface, and angle between a rear wheel axis of a tractor and the trailer;
at least one poly-phase electric motor coupled to a wheel to apply one of positive drive torque and negative braking torque;
an anti-jackknife control circuit coupled to said sensor system to determine and transmit anti-yaw commands to an adaptive field-oriented motor controller; and
the adaptive field-oriented motor control coupled to the at least one poly-phase electric motor to provide current and phase to generate a horizontal yaw force counter to jackknifing.

2. The trailer of claim 1 further comprising a power generation, storage, and distribution subsystem independent of the tractor.

3. An articulated vehicle comprises:
an anti-jackknifing vehicle control circuit;
at least one voltage and current motor controller;
at least one electric motor coupled to a wheel; and
a trailer.

4. The articulated vehicle of claim 3 further comprising:
a tractor coupled to the trailer by a fifth wheel coupling; and
sensors to determine when the tractor is both skidding and out of alignment to the trailer.

5. The articulated vehicle of claim 4 wherein said tractor comprises a motor controller coupled to the fifth wheel coupling to whereby voltage and current are applied to oppose increased folding of the articulated vehicle.

6. The articulated vehicle of claim 4 wherein said tractor comprises:
a plurality of AC motors; and
at least one AC motor controller whereby AC phase and magnitude are applied to said motors to oppose increased folding of the articulated vehicle.

7. The articulated vehicle of claim 4 wherein said tractor comprises the vehicle anti-jackknife control circuit coupled to said sensors whereby a first AC motor controller provides a first AC phase and magnitude to port motors to generate a horizontal yaw force counter to jackknifing and a second AC motor controller provides a second AC phase and magnitude to starboard motors to generate a horizontal yaw force counter to jackknifing.

8. The articulated vehicle of claim 4 wherein said trailer comprises a motor controller coupled to the fifth wheel coupling whereby voltage and current are applied to oppose increased folding of the articulated vehicle.

9. The articulated vehicle of claim 7 wherein said trailer comprises:
a plurality of AC motors; and
at least one AC motor controller whereby AC phase and magnitude are applied to said motors to oppose increased folding of the articulated vehicle.

10. The articulated vehicle of claim 7 wherein said trailer comprises:
the vehicle anti-jackknife control circuit coupled to
said sensors whereby a first AC motor controller provides a first AC phase and magnitude to port motors to generate a horizontal yaw force counter to jackknifing and
a second AC motor controller provides a second AC phase and magnitude to starboard motors to generate a horizontal yaw force counter to jackknifing.

11. The articulated vehicle of claim 8 wherein said trailer further comprises:
a regenerative braking circuit; coupled to
a DC storage battery, said battery coupled to
at least one AC motor controller.

12. The articulated vehicle of claim 9 wherein said tractor further comprises:
the vehicle anti-jackknife control circuit coupled to said sensors whereby a first AC motor controller provides a first AC phase and magnitude to port motors to generate a horizontal yaw force counter to jackknifing and a second AC motor controller provides a second AC phase and magnitude to starboard motors to generate a horizontal yaw force counter to jackknifing; whereby the yaw forces of the tractor cause a clockwise moment and the yaw forces of the trailer cause a counter clockwise moment combined at a kingpin.

13. An anti-jackknifing apparatus for an articulated vehicle comprises:
a plurality of electric motors adapted to apply torque to wheels;
a current control circuit coupled to the plurality of electric motors and further coupled to a vehicle control circuit; and
a plurality of sensors to determine skidding, sliding, and orientation.

14. The apparatus of claim 13 wherein at least one motor is coupled to a fifth wheel to apply torque in resistance to folding of the articulated vehicle.

15. The apparatus of claim 13, wherein a plurality of motors are configured to individually produce positive torque to wheels on a port side and negative torque to wheels on a starboard side.

16. The apparatus of claim 13 wherein the current control circuit provides alternating current (AC) at a first phase and magnitude for motors associated with port side wheels and at a second phase and magnitude for motors associated with starboard side wheels.

17. The apparatus of claim 13 where said sensors are coupled to the vehicle control unit to trigger currents applied to the motors.

18. The apparatus of claim 13 further comprising:
an electrical power source coupled to the current control circuit and
regenerative braking circuits are coupled to the electrical power source.

19. A method for operation of an articulated vehicle controller and anti-jackknife apparatus comprising:
sensing from vehicle movement, wheel rotation, and orientation a condition of imminent jackknifing movement;
determining a desired angular moment to apply to a vehicle component to forestall a folding of the articulated vehicle; and
provisioning at least one AC motor with a first current phase and current magnitude until the jackknifing movement is reversed.

20. The method of claim 19 wherein provisioning at least one AC motor comprises:
measuring a current rate of wheel rotation;
generating an interference electrical signal of frequency above or below the current rate; and
adjusting the magnitude of the current to cause the motor to lag or lead the wheel rotation.

21. The method of claim 19 wherein a vehicle component is a tractor and a desired angular moment is a yaw of the tractor into closer alignment with the trailer by:
generating positive torque at the electric motors of the tractor interior to the jackknifing movement of the articulated vehicle.

22. The method of claim 19 wherein a vehicle component is a trailer and a desired angular moment is a yaw of the trailer into closer alignment with the tractor by:
generating negative torque at the electric motors of the trailer interior to the jackknifing movement of the articulated vehicle; and
generating positive torque at the electric motors of the trailer exterior to the jackknifing movement of the articulated vehicle.
